(19) United States
(12) Patent Application Publication
(10) Pub. No.: US 2009/0111935 A1
(43) Pub. Date: Apr. 30, 2009

(54) Aqueous urethane resin compositions

(75) Inventors: Takeshi Fujii, Hiratsuka-shi (JP); Hiromi Harakawa, Hiratsuka-shi (JP)

Correspondence Address: WENDEROTH, LIND & PONACK, L.L.P., 1030 15th Street, N.W.,, Suite 400 East, Washington, DC, 20005-1503, US

(73) Assignee: KANSAI PAINT CO., LTD.

(21) Appl. No.: 12/289,457

(22) Filed: Oct. 28, 2008

(30) Foreign Application Priority Data
Oct. 29, 2007 (JP) 2007-280994
Oct. 31, 2007 (JP) 2007-282666

(51) Int. Cl. C08G 18/08

(52) U.S. Cl. 524/507

(57) ABSTRACT

This invention offers an aqueous urethane resin composition which contains a urethane resin obtained through reaction of acrylic polyol formed by copolymerization of carbonyl functional group-containing unsaturated monomer, hydrophilic group-containing unsaturated monomer and, where necessary, still other unsaturated monomer; with polyisocyanate compound and, where necessary, carboxyl group-containing diol; can form film of excellent physical properties such as spreadability and flexibility; and becomes ambient temperature-curable when combined with a crosslinking agent.

### TECHNICAL FIELD

This invention relates to highly stable aqueous urethane resin compositions and one-package type water-based paint compositions containing the same.

### BACKGROUND ART

Urethane resin can form film excelling in extendability and strength, and hence has been frequently used as binder, particularly in the art of coating. However, two-package type urethane resin binder, which is used by mixing isocyanate compound with polyol compound at the time of use, has a drawback of poor handling property such as the risk of skin poisoning by the isocyanate and wide variation in binder properties at different mixing ratios. Furthermore, isocyanate compound reacts with water and is deactivated, and organic solvent must be used in large quantities as the diluting solvent, which causes environmental pollution with VOC.

For these reasons, development of water-based coating or water-based paint using one-package type urethane resin binder free of such problems has heretofore been promoted.

For example, JP Hei 2 (1990)-6572A disclosed a self-crosslinkable water-based coating composition formed of an aqueous dispersion containing at least one kind of polyurethane polymer having hydrazine or hydrazone functional groups and carbonyl functional groups.

JP Hei 7 (1995)-233347A disclosed an aqueous dispersion of self-crosslinkable water-based binder formed of carbonyl group-containing urethane-vinyl-hybrid polymer and polyhydrazides, said hybrid polymer being obtained by free radical-initiated polymerization of vinyl group-containing urethane macromonomer with other vinyl monomers, using in that occasion carbonyl group-containing monomer as at least a part of the other vinyl monomers.

JP 2000-119361A disclosed an aqueous acrylic-urethane copolymer composition formed by chain-extending a neutralized, isocyanate-terminated prepolymer in water, using at least one chain-extending agent selected from water-soluble polyamines and hydrazine derivatives, said prepolymer being obtained from organic polyisocyanate compound, high molecular weight polyol and a compound having anionic hydrophilic group and at least two active hydrogen atoms in its molecule.

Many aqueous urethane resin compositions having been proposed as above, these aqueous urethane resin compositions are subject to such problems as cumbersome production processes, and that the cured coating films formed of the compositions show insufficient physical properties such as elongation and flexibility.

### DISCLOSURE OF THE INVENTION

The object of the present invention is to offer aqueous urethane resin compositions which excels in storage stability, is curable at ambient temperature as combined with crosslinking agent, and can form film of excellent properties such as elongation and flexibility; and also one-package type water-based paint compositions containing the aqueous urethane resin compositions.

We have made concentrative studies to now discover that the above object could be accomplished by a urethane resin synthesized from acrylic polyol and polyisocyanate compound, the acrylic polyol being obtained by copolymerization of carbonyl functional group-containing unsaturated monomer and hydrophilic unsaturated monomer, with suitably other unsaturated monomer; and come to complete the present invention.

Thus, the present invention offers an aqueous resin composition containing a urethane resin as dispersed in an aqueous medium, which is obtained through reaction of 50-90 mass % of (A) acrylic polyol formed by copolymerization of carbonyl functional group-containing unsaturated monomer, hydrophilic group-containing unsaturated monomer and, where necessary, still other unsaturated monomer; with 10-50 mass % of (B) polyisocyanate compound, based on the total mass of the components (A) and (B).

Hereinafter the aqueous resin composition of the present invention is explained in further details.

### (A) Acrylic Polyol:

The acrylic polyol (A) which is used as the polyol component for producing the urethane resin according to the invention is obtained by copolymerization of carbonyl functional group-containing unsaturated monomer (a-1), hydrophilic group-containing unsaturated monomer (a-2) and, where necessary, still other unsaturated monomer (a-3).

The acrylic polyol (A) preferably meets the following two requirements:

a) the acrylic polyol (A) contains at least two but not an excessive number of hydroxyl groups per molecule.

Where the number of hydroxyl groups in the alcohol component to react with the polyisocyanate compound is less than two, chain extension of formed polyurethane resin becomes insufficient, and a stable aqueous dispersion may not be obtained. Conversely, where the number of hydroxyl groups in the alcohol component is excessive, such as five or more, three-dimensional crosslinkage takes place during the reaction with polyisocyanate compound, in high possibility causing insolubilization of the resin due to gel formation. Thus, generally the acrylic polyol (A) preferably has 2-4 hydroxyl groups per molecule.

b) The acrylic polyol has hydroxyl groups at least at the molecular chain terminals.

If acrylic polyol used has hydroxyl groups only at the central part of its molecular chain, when the hydroxyl groups react with isocyanate groups to form urethane linkages, the product will have such a structure that acrylic molecular chains extend to both sides of the urethane linkage, which may render stability of resultant aqueous dispersion of the resin insufficient.

Use of the acrylic polyol (A) satisfying above two requirements a) and b) gives a urethane resin excelling in dispersibility in water and storage stability.

Unsaturated monomers (a-1), (a-2) and (a-3) which are used for production of the acrylic polyol (A), and production of the acrylic polyol (A) are specifically described in the next.

Carbonyl functional group-containing unsaturated monomer (a-1) is a compound having at least one, preferably one or two, carbonyl groups (>C═O) and one polymerizable unsaturated bond per molecule. Specific examples include acrolein, diacetone acrylamide, diacetone methacrylamide, diacetone acrylate, diacetone methacrylate, formylstyrol, C₄₋₇ vinyl alkyl ketones (e.g., vinyl methyl ketone, vinyl ethyl ketone, vinyl butyl ketone) and the like. Of these, diacetone acrylamide and diacetone methacrylamide are particularly preferred.

Hydrophilic group-containing unsaturated monomer (a-2) is a compound containing at least one hydrophilic group and one polymerizable unsaturated bond per molecule, the hydrophilic group including, for example, anionic hydrophilic groups such as carboxyl group, sulfonic acid group and the like; latent anionic hydrophilic groups such as acid anhydride group; nonionic hydrophilic groups such as amido group, substituted amido group, polyoxyalkylene group, pyridyl group, piperidyl group and the like; and cationic groups such as dialkyl amino group, quaternary ammonium group and the like. Thus, specific examples of hydrophilic group-containing unsaturated monomer (a-2) include anionic hydrophilic group-containing unsaturated monomers such as acrylic acid, methacrylic acid, maleic acid, fumaric acid, itaconic acid, citraconic acid, crotonic acid, β-acryloyloxypropionic acid, β-carboxyethyl acrylate, vinylsulfonic acid, styrenesulfonic acid, 2-(meth)acrylamido-2-methylpropanesulfonic acid, 2-(meth)acryloylethanesulfonic acid, 2-(meth)acryloylpropanesulfonic acid and the like; latent anionic hydrophilic group-containing unsaturated monomers such as maleic anhydride, fumaric anhydride, itaconic anhydride, citraconic anhydride and the like, in which carboxylic acid groups are regenerated by half-esterification with hydroxyl group-containing compounds; nonionic hydrophilic group-containing unsaturated monomers such as acrylamide, methacrylamide, N-methyl (meth)acrylamide, N-ethyl (meth)acrylamide, N-n-propyl (meth)acrylamide, N-ethyl (meth)acrylamide, N-n-propyl (meth)acrylamide, N-isopropyl (meth)acrylamide, N,N-dimethyl (meth)acrylamide, methoxypolyethylene glycol (meth)acrylate, vinylpyridine, N-vinylpyrrolidone, N-acryloylpiperidine, N-acryloylpyrrolidine and the like; and cationic hydrophilic group-containing unsaturated monomers such as N,N-dimethylaminoethyl (meth)acrylate, N,N-diethylaminoeothyl (meth)acrylate, N,N-dimethylaminopropyl (meth)acrylate, N,N-dimethylaminopropyl (meth)acrylamide and their quaternary salts. Of these, anionic hydrophilic group-containing unsaturated monomers, in particular, carboxyl group-containing unsaturated monomers, inter alia, acrylic acid and methacrylic acid, are preferred.

Other unsaturated monomers (a-3) include those compounds which contain one unsaturated bond per molecule and are copolymerizable with above monomers (a-1) and/or (a-2). They can be used either alone or in combination of two or more, according to the physical properties desired for the produced acrylic polyol (A). Examples of such other unsaturated monomers (A-3) include hydroxyl group-containing monomers such as hydroxyl group-containing (meth)acrylates like C₂₋₈ hydroxyalkyl (meth)acrylates including 2-hydroxyethyl (meth)acrylate, 2-hydroxypropyl (meth)acrylate, 3-hydroxypropyl (meth)acrylate, hydroxybutyl (meth)acrylate and the like, allyl alcohol, ε-caprolactone modified C₂₋₈ hydroxyalkyl (meth)acrylates as named above, and (meth)acrylates having polyoxyethylene chain with end hydroxyl group; C₁₋₁₈ alkyl or C₃₋₁₂ cycloalkyl (meth)acrylates such as methyl (meth)acrylate, ethyl (meth)acrylate, n-propyl (meth)acrylate, i-propyl (meth)acrylate, n-butyl (meth)acrylate, i-butyl (meth)acrylate, tert-butyl (meth)acrylate, n-hexyl (meth)acrylate, octyl (meth)acrylate, 2-ethylhexyl (meth)acrylate, nonyl (meth)acrylate, tridecyl (meth)acrylate, lauryl (meth)acrylate, stearyl (meth)acrylate, isostearyl (meth)acrylate, cyclohexyl (meth)acrylate, methylcyclohexyl (meth)acrylate, t-butylcyclohexyl (meth)acrylate, cyclododecyl (meth)acrylate and the like; isobornyl group-containing polymerizable unsaturated compounds such as isobornyl (meth)acrylate; adamantly group containing polymerizable unsaturated compounds such as adamantyl (meth)acrylate; vinyl aromatic compounds such as styrene, α-methylstyrene, vinyltoluene, and the like; C₁₋₁₈ perfluoroalkyl (meth)acrylates such as perfluorobutylethyl (meth)acrylate, perfluorooctylethyl (meth)acrylate and the like; polymerizable unsaturated compounds having fluorinated alkyl group, such as fluoroolefin; vinyl compounds such as ethylene, butadiene, chloroprene, vinyl propionate, vinyl acetate and the like; and epoxy group-containing polymerizable unsaturated monomers such as glycidyl (meth)acrylate, β-methylglycidyl (meth)acrylate, 3,4-epoxycyclohexylmethyl (meth)acrylate, 3,4-epoxycycohexylethyl (meth)acrylate, 3,4-epoxycyclohexylpropyl (meth)acrylate, allyl glycidyl ether and the like.

Copolymerization of above-described carbonyl functional group-containing unsaturated monomer (a-1), hydrophilic group-containing unsaturated monomer (a-2) and, where necessary, still other unsaturated monomer (a-3) can be carried out by the methods known per se, for example, by the following methods.

(i) A method comprising polymerizing a carbonyl functional group-containing unsaturated monomer (a-1), hydrophilic group-containing unsaturated monomer (a-2) and, where necessary, still other unsaturated monomer (a-3) in organic solvent by solution polymerization process or the like, in the presence of 2,4-disubstituted-4-methyl-1-pentene expressed by the formula (1) below,

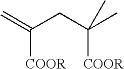

in the formula, R stands for a hydroxyl group-containing hydrocarbon group, for example, C₂₋₈ hydroxyalkyl group such as hydroxyethyl, hydroxypropyl, hydroxybutyl and the like,
   which is known to act as an addition-fragmentation chain transfer agent in radical polymerization reaction systems, and a radical polymerization initiator, to form a telechelic type acrylic polyol of the formula (2) below,

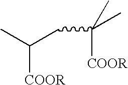

in the formula, R is same as above-defined.

Incidentally, 2,4-disubstituted-4-methyl-1-pentene of above formula (1) is known per se, and can be obtained by, for example, polymerizing hydroxyl group-containing methacrylic acid ester of the formula (3) below,

CH₂═C(CH₃)—COOR
in the formula, R is same as above-defined, free of solvent or in organic solvent in the presence of a metal complex serving as a catalytic chain transfer agent and radical polymerization initiator, following catalytic chain transfer polymerization process [e.g., see JP Hei 6 (1994)-23209B, JP Hei 7 (1995)-35411B, JP Tokuhyo Hei 9 (1997)-501457A, JP Hei 9 (1997)-176256A, and “Macromolecules”, 1996, 29, 8083-8089].

(ii) A method comprising polymerizing a carbonyl functional group-containing unsaturated monomer (a-1), hydrophilic group-containing unsaturated monomer (a-2) and, where necessary, still other unsaturated monomer (a-3) in organic solvent by solution polymerization process or the like, in the presence of a hydroxyl group-containing thiol compound serving as a chain transfer agent, which is expressed by the formula (4) below,

R—SH
in the formula, R is same as above-defined, such as 2-mercaptoethanol, and a radical polymerization initiator, to form an acrylic polyol having at its molecular terminus RS-group;

in this method, hydroxyl groups can be introduced not only to termini of the acrylic polyol's molecular chain but also into the sites other than the molecular chain termini (e.g., in the vicinity of center of the molecular chain), by blending with the unsaturated monomers (or their mixture) to be polymerized, a hydroxyl group-containing monomer. The total amount of hydroxyl groups per molecule of the formed acrylic polyol can be adjusted to be 2-4, by adjusting the blending amount of the hydroxyl group-containing monomer.

It is preferable to carry out the polymerization by either of the above methods (i) and (ii), whereby acrylic polyol meeting the aforesaid two requirements can be obtained.

The use ratios of the carbonyl functional group-containing unsaturated monomer (a-1), hydrophilic group-containing unsaturated monomer (a-2) and, where necessary, still other unsaturated monomer (a-3), based on the total mass of the monomers (a-1), (a-2) and (a-3), can be as follows:
monomer (a-1): generally 2-50 mass %, preferably 5-40 mass %, inter alia, 10-30 mass %;
monomer (a-2): generally 0.1-30 mass %, preferably 0.5-25 mass %, inter alia, 1-20 mass %;
monomer (a-3): generally 30-98 mass %, preferably 40-95 mass %, inter alia, 50-90 mass %;

Thus obtained acrylic polyol (A) can have a number-average molecular weight within a range of generally 400-10,000, preferably 1,000-8,000, inter alia, 1,200-3,000.

Where later described carboxyl group-containing diol (C) is not co-used, the acrylic polyol (A) can have an acid value generally not higher than 100 mgKOH/g, preferably within a range of 10-80 mgKOH/g, inter alia, 20-70 mgKOH/g; and when the later described carboxyl group-containing diol (C) is co-used, the acrylic polyol (A) can have an acid value not higher than 50 mgKOH/g, preferably within a range of 5-40 mgKOH/g, inter alia, 10-30 mgKOH/g. When the acid value of acrylic polyol becomes higher than the above-specified respective ranges, swelling of dispersed particles in resultant aqueous urethane resin dispersion may take place to impair stability.

Furthermore, acrylic polyol (A) can have a hydroxyl value within a range of generally 15-180 mgKOH/g, preferably 15-150 mgKOH/g, inter alia, 20-100 mgKOH/g.

In the present specification, number-average molecular weight of acrylic polyol (A) is the value measured by GPC process following the method prescribed by JIS K0124-83 under the conditions of: temperature, 40° C.; flow rate, 1.0 mL/min.; using tetrahydrofuran for GPC as the eluent; and calculated on calibration curve of standard polystyrene. As the GPC device, HLC8120GPC (tradename, Tosoh Corporation) was used and as the columns TSKgel G-4000HXL, TSKgel G-300HXL, TSKgel G-2500-HXL and TSKgel G-2000HXL (tradename, Tosoh Corporation) were used in combination.

It is convenient to convert the acrylic polyol (A) to a varnish by diluting it with a suitable amount of a solvent, to smoothly progress the reaction for synthesizing later-described urethane resin. The diluting solvent useful in that occasion preferably is a polar solvent which is inert to isocyanate and, in the subsequent dispersing in water, allows formation of homogeneous aqueous dispersion free of agglomerates. Examples of the solvent include acetone, methyl ethyl ketone, methyl isobutyl ketone, cyclohexanone, N-methylpyrrolidone, ethyl acetate, tetrahydrofuran, dimethylformamide, dioxane and the like.

### (B) Polyisocyanate Compound:

Polyisocyanate compound (B) which is to react with the polyol component in the production of urethane resin according to the present invention is a compound containing at least two, preferably two to three, isocyanate groups, specific examples of which include aliphatic diisocyanates such as hexamethylene diisocyanate, trimethylhexamethylene diisocyanate, dimeric acid diisocyanate, lysine diisocyanate and the like, and biuret type adducts and isocyanurate ring adducts of these diisocyanates; alicyclic diisocyanates such as isophorone diisocyanate, 4,4′-methylenebis-(cyclohexyl isocyanate), methylcyclohexane-2,4-(or 2,6-)diisocyanate, 1,3- or 1,4-di(isocyanatomethyl)cyclohexane, 1,4-cyclohexane diisocyanate, 1,3-cyclopentane diisocyanate, 1,2-cyclohexane diisocyanate and the like, biuret-type adducts and isocyanurate ring adducts of these diisocyanates; aromatic diisocyanate compounds such as xylylene diisocyanate, metaxylylene diisocyanate, tetramethylxylylene diisocyanate, tolylene diisocyanate, 4,4′-diphenylmethane diisocyanate, 1,5-naphthalene diisocyanate, 1,4-naphthalene diisocyanate, 4,4′-toluidine diisocyanate, 4,4′-diphenylether diisocyanate, m- or p-phenylene diisocyanate, 4,4′-biphenylene diisocyanate, 3,3′-dimethyl-4,4′-biphenylene diisocyanate, bis(4-isocyanatophenyl)sulfone, isopropylidenebis(4-phenyl isocyanate) and the like, biuret type adducts and isocyanurate ring adducts of these diisocyanates; polyisocyanates having at least three isocyanate groups per molecule such as triphenylmethane-4,4′-4″-triisocyanate, 1,3,5-triisocyanatobenzene, 2,4,6-triisocyanatotoluene, 4,4′-dimethyldiphenylmethane-2,2′,5,5′-tetraisocyanate and the like, biuret type adducts and isocyanurate ring adducts of these polyisocyanates; and urethanated adducts formed by reacting such polyols as ethylene glycol, propylene glycol, 1,4-butylene glycol, dimethylolpropionic acid, polyalkylene glycol, trimethylolpropane, hexanetriol and the like with polyisocyanate compound at such ratios that the isocyanate groups become excessive to the hydroxyl groups of the polyol, biuret type adducts and isocyanurate ring adducts of these polyisocyanates.

Of these, from the viewpoint not to induce gelation by three-dimentional crosslinkage in the urethane-forming reaction with acrylic polyol, use of diisocyanate compounds such as aliphatic diisocyanates, e.g., hexamethylene diisocyanate, trimethylhexamethylene diisocyanate, dimeric acid diisocyanate and lysine diisocyanate; alicyclic diisocyanates such as isophorone diisocyanate, 4,4′-methylenebis(cyclohexyl isocyanate), methylcyclohexane-2,4- or -2,6-diisocyanate, 1,3- or 1,4-di(isocyanatomethyl)cyclohexane, 1,4-cyclohexane diisocyanate, 1,3-cyclopentane diisocyanate and 1,2-cyclohexane diisocyanate; and aromatic diisocyanates such as xylylene diisocyanate, metaxylylene diisocyanate, tetramethylxylylene diisocyanate, tolylene diisocyanate, 4,4′-diphenylmethane diisocyanate, 1,5-naphthalene diisocyanate, 1,4-naphthalene diisocyanate, 4,4′-toluidine diisocyanate, 4,4′-diphenylether diisocyanate, m- or p-phenylene diisocyanate, 4,4′-biphenylene diisocyanate, 3,3′-dimethyl-4,4′-biphenylene diisocyanate, bis(4-isocyanatophenyl)sulfone and isopropylidenebis(4-phenyl isocyanate) is preferred.

These polyisocyanate compounds can be used either alone or in combination of two or more.

### (C) Carboxyl Group-Containing Diol:

In the present invention, a part of the acrylic polyol (A) may be replaced with carboxyl group-containing diol (C) as a chain extending agent, where necessary in the occasion of producing the urethane resin. Use of the carboxyl group-containing diol (C) causes the resulting urethane resin to contain the resin structure in which the moiety rendering the resin water-dispersible and urethane linking moiety are adjacent to each other, which suppresses aggregation of particles in the aqueous dispersion to improve storage stability.

Examples of the carboxyl group-containing diol (C) include dihydroxycarboxylic acids such as dimethylolpropionic acid, dimethylolbutanoic acid, dimethylolvaleric acid, tartaric acid, mevalonic acid, resorcylic acid and the like. Of these, dimethylolpropionic acid, dimethylolbutanoic acid and dimethylolvaleric acid are preferred. These carboxyl group-containing diols can be used either alone or in combination of two or more.

### Production of Urethane Resin:

The urethane resin of the present invention can be produced by single-stage or multi-stage reaction of acrylic polyol (A) with polyisocyanate compound (B) and, where necessary, carboxyl group-containing diol (C) following the per se known urethane synthesizing process, preferably in an organic solvent which is inert to isocyanate group. The use ratios of the components (A), (B) and (C) in that occasion can be: where no carboxyl group-containing diol (C) is used, based on the combined mass of the components (A) and (B), the acrylic polyol (A), within a range of 50-90 mass %, preferably 60-90 mass %, and the polyisocyanate compound, within a range of 10-50 mass %, preferably 10-40 mass %; also when the carboxyl group-containing diol (C) is used, based on the total mass of the components (A), (B) and (C), the acrylic polyol (A), within a range of 50-80 mass %, preferably 60-80 mass %, the polyisocyanate compound (B), within a range of 10-49.9 mass %, preferably 15-40 mass %, and the carboxyl group-containing diol (C), within a range of 0.1-30 mass %, preferably 2-10 mass %. In the explanation hereinafter the acrylic polyol (A) and carboxyl-containing diol (C) may be collectively referred to as “polyol component of the present invention”.

The use ratio of the polyol component of the present invention to the polyisocyanate compound (B) is variable, while it is desirable that the ratio falls within a range of generally 0.3:1-3.3:1, preferably 0.35:1-2.5:1, inter alia, 0.4:1-1.6:1, in terms of equivalent ratio of the total hydroxy groups in the polyol component of the present invention to isocyanate groups in the polyisocyanate compound (B). When the equivalent ratio deviates from the above range, dispersed state of resultant urethane resin in water is apt to become unstable.

The reaction of the acrylic polyol (A) with polyisocyanate compound (B) and, where necessary, carboxyl group-containing diol (C) can be carried out normally at 40-180° C., preferably 60-130° C. Also for accelerating the reaction, amine catalyst such as triethylamine, N-ethylmorpholine, triethylenediamine and the like or tin catalyst such as dibutyltin dilaurate, dioctyltin dilaurate and the like, can be used where necessary, as in ordinary urethanation reaction.

Thus obtained polyurethane resin preferably has an acid value within a range of generally 5-50 mgKOH/g, in particular, 10-45 mgKOH/g, inter alia, 15-40 mgKOH/g, from the viewpoint of dispersibility in water. When acid value of the polyurethane resin is less than 5 mgKOH/g, its dispersibility in water may become insufficient. Conversely, when it exceeds 50 mgKOH/g, water resistance of resulting coating film may become insufficient.

### Dispersion of the Polyurethane Resin:

The polyurethane resin produced as above is dispersed in an aqueous medium. The aqueous medium is a medium of which chief component is water, optionally containing as a sub-component polar solvent or ionic water-soluble component like low molecular weight amine, normally at a ratio not higher than 25 mass %, preferably not more than 15 mass % to the total mass of the medium.

Dispersion of the polyurethane resin in an aqueous medium can be effected by the means known per se, for example, by neutralizing the acidic groups contained in the polyurethane resin with a basic compound, and then adding water thereto under agitation with gradually increased intensity to convert it to an aqueous dispersion. In that occasion, forced emulsification system may also be used. For example, an advancedly neutralized polyurethane resin solution is premixed with deionized water to attain a prescribed concentration, then forcedly emulsified with ultra-high pressure homogenizer (e.g., Altemizer System, tradename, Sugino Machine Limited) under high pressure condition to provide an emulsion (aqueous dispersion). It is also permissible to partially progress chain-extension reaction with the aqueous medium, simultaneously with the dispersion, or to further continue the chain-extending reaction using a chain-extending agent to increase the degree of polymerization. Examples of useful chain-extending agent include diamines such as ethylenediamine, 1,2-propanediamine, 1,6-hexamethylenediamine, piperazine, 2,5-dimethylpiperazine, isophoronediamine, 4,4′-dicyclohexylmethanediamine, 3,3′-dimethyl-4,4′-dicyclohexylmethanediamine, 1,4-cyclohexanediamine, polyoxyethylenediamine, polyoxypropylenediamine, amine-terminated polyoxyethylene-polyoxypropylene copolymer and the like; polyamines such as diethylenetriamine, dipropylenetriamine, triethylenetetramine, tetraethylenepentamine and the like; compounds having amino groups and hydroxyl groups such as hydroxyethylhydrazine, hydroxyethyldiethylenetriamine, 2-[(2-aminoethyl)amino]ethanol, 3-aminopropanediol and the like; hydrazines and acid hydrazides. These can be used either alone or in combination of two or more.

Examples of the basic compound useful for neutralization of the polyurethane resin include organic amine compounds such as monomethylamine, dimethylamine, trimethylamine, monoethylamine, triethylamine, monoisopropylamine, diisopropylamine, diethylenetriamine, triethylenetetramine, monoethanolamine, diethanolamine, triethanolamine, monoisopropanolamine, diisopropanolamine, dimethylethanolamine, 2-aminomethylpropanol, morpholine, methylmorpholine, piperazine and the like; ammonia, sodium hydroxide, potassium hydroxide, lithim hydroxide, and the like. In particular, use of organic amine compound is preferred. The neutralization equivalent is generally preferably within a range of 0.4-1.2. Under such an acid-excessive condition that the neutralization equivalent is less than 0.4, in certain occasions the conversion to stable aqueous dispersion is impossible. Conversely, under the condition of the basic compound's excess such that the neutralization equivalent is higher than 1.2, there may occur such problems as odor of the organic amine compound or ammonia, or skin poisoning with inorganic alkali.

Furthermore, for reducing the VOC component such as organic solvent in the intended aqueous resin composition, the aqueous dispersion of the urethane resin may be suitably subjected to, for example, reduced pressure distillation to reduce its VCO component.

After volatilization of the aqueous medium from the aqueous resin compositions comprising the resulting aqueous dispersion of urethane resin, the urethane resin rich in cohesive power forms extendable film of excellent physical properties. Hence the compositions can be favorably used as binder for air drying paint.

### Preparation of Ambient Temperature-Curable Aqueous Resin Compositions:

Where necessary, hydrazine compound and/or hydrazide compound may further be blended in the aqueous resin compositions of the present invention, to impart ambient temperature curability.

As typical examples of the hydrazine compound, hydrazine, hydrazine hydrate (NH₂NH₂.H₂O), monomethylhydrazine, monoethylhydrazine and the like can be named, hydrazine and hydrazine hydrate being preferred.

Specific examples of the hydrazide compound include C₂₋₁₈ saturated dicarboxylic dihydrazides such as oxalic dihydrazide, malonic dihydrazide, glutaric dihydrazide, succinic dihydrazide, adipic dihydrazide, sebacic dihydrazide and the like; monoolefinic unsaturated dicarboxylic dihydrazides such as maleic dihydrazide, fumaric dihydrazide, itaconic dihydrazide and the like; phthalic dihyrazide, terephthalic dihydrazide or isophthalic dihydrazide; dihyrazide, trihydrazide or tetrahydrazide of pyromellitic acid; nitirilotrihydrazide, citric trihydrazide, 1,2,4-benzene trihydrazide, ethylenediaminetetraacetic tetrahydrazide, 1,4,5,8-naphthoic 30′ tetrahydrazide; polyhydrazides obtained by reaction of low molecular weight polymers having carboxylic acid lower alkyl ester groups with hydrazine or hydrazine hydrate; hydrazide group-containing compounds such as carbonic dihydrazide; bis-semicarbazide; polyfunctional semicarbazides obtained by reaction of diisocyanate such as hexamethylene diisocyanate or isophorone diisocyanate or polyisocyanate compound derived therefrom with excessive N,N-substituted hydrazine such as N,N-dimethylhydrazine or above-exemplified hydrazides (e.g., HARDER SC: tradename, Asahi Kasei Chemicals Corporation, a 50% aqueous solution of aqueous polyfunctional semicarbazide), aqueous polyfunctional semicarbazides obtained by reacting isocyanate groups in the reaction products of the polyisocyanate compounds with polyether and active hydrogen compound containing hydrophilic group, such as polyols or polyethylene glycol monoalkyl ethers, with an excess of above-exemplified dihydrazide; semicarbazide group-containing compounds such as mixtures of the polyfunctional semicarbazides and aqueous polyfunctional semicarbazides; and hydrazone group-containing compounds such as bisacetyldihydrazone. Of these, dicarboxylic dihydrazides and polyfunctional semicarbazides are preferred.

These hydrazine compounds and hydrazide compounds can be used either alone or in combination of two or more.

While the use rate of the hydrazine compound and/or hydrazide compound is not particularly limited, it can be normally within a range of 1-40 mass %, preferably 5-20 mass %, based on the mass of the urethane resin.

### One-Package Type Water-Based Paint Compositions:

The aqueous resin compositions of the present invention can be formulated into transparent or semi-transparent one-package type water-based paint compositions, either as they are or as blended with generally used paint additives such as defoamer, thickener, film-forming assistant, antiseptic, antifungus agent, antifreezing agent, pH regulating agent, flash rust inhibitor, aldehyde scavenger, laminar clay minerals, surfactant, surface-regulating agent, plasticizing agent, antisettling agent, antistatic agent, antibacterial agent, perfume, UV absorber, UV stabilizer, anti-fouling agent such as alkylene glycol-modified alkyl silicate and the like.

The aqueous resin compositions of the present invention can also be blended with per se known coloring pigment, extender pigment, rust-proofing pigment and the like as a pigment component, and furthermore with suitably selected combination of pigment-dispersing agent, dispersant, powdery or fine particulate activated carbon, photocatalytic titanium oxide and the like, to be formulated into one-package type water-based coloring paint compositions.

The objects to be coated with the one-package type water-based paint compositions of the present invention are not particularly limited, which can be substrates such as of metals, e.g. iron, aluminum and the like; organic substrates such as plastics; inorganic substrates such as concrete blocks, wood, stone and the like; and coating films on such substrates. As the coating films, for example, those of acrylic resin, acrylic urethane resin, polyurethane resin, fluorinated resin, silicone acrylic resin, vinyl acetate resin, epoxy resin, alkyd resin and the like can be named. These coated surfaces may also be those subjected to chemical conversion treatment or given undercoating or intermediate coating. It is also possible to apply known paint after application of a paint composition of the present invention.

Application of the one-package type water-based paint composition of the invention can be done with per se known means, such as air spray, airless spray, texture gun, universal gun, roller, brush, electrostatic coating and the like. As the drying means, any of air drying, forced drying and heat-drying can be used, which may be suitably selected according to individual composition. In the present specification, drying at temperatures less than 40° C. is referred to as air drying, that at not lower than 40° C. but less than 80° C., as forced drying, and that of 80° C. or higher, as heat-drying.

Thus, by the use of the water-based paint compositions of the present invention, objects having spreadable coating film of excellent physical properties can be obtained.

### EXAMPLES

Hereinafter the invention is explained more specifically, referring to Synthesis Examples, Working Examples and Comparative Examples, it being understood that the invention is in no way limited by those Examples. “Part” and “%” are both by mass.

### Synthesis Example 1

### Synthesis of Acrylic Polyol without Using a Chain Transfer Agent

A flask was charged with 40 parts of N-methylpyrrolidone which was stirred at 150° C. while blowing nitrogen thereinto, and into which a mixture of 15 parts of styrene, 13 parts of isobutyl methacrylate, 30 parts of 2-ethylhexyl acrylate, 20 parts of diacetone acrylamide, 17 parts of 2-hydroxyethyl methacrylate, 5 parts of acrylic acid and 4 parts of PERHEXYL D (tradename, NOF Corporation, peroxide-type radical polymerization initiator) was added dropwise over 4 hours. After completion of the dropping, the reaction mixture was left standing at 150° C. for an hour, to which further a mixed solution of 0.5 part of 2,2′-azobisisobutyronitrile and 3 parts of N-methylpyrrolidone was added dropwise over 30 minutes. After completion of the dropping, the reaction mixture was allowed to stand at 150° C. for an hour to provide an acrylic polyol solution (AP-1) having a solid content of 70%. The resultant acrylic polyol had a number-average molecular weight of 1,730 acid value of 39 mgKOH/g and hydroxyl value of 73 mgKOH/g. The calculated number of hydroxyl groups per molecule (calculated from the number-average molecular weight and the hydroxyl value) was 2.3.

### Synthesis Examples 2

Synthesis Example 1 was repeated except that the monomer blend as shown in later given Table 1 was used and the reaction temperature was made 130° C., to provide an acrylic polyol solution (AP-7) having a solid content of 70%. The number-average molecular weight, acid value, hydroxyl value and calculated hydroxyl group number per molecule are shown in later appearing Table 2.

### Synthesis Example 3

### Synthesis of Hydroxyl Group-Containing Methacrylic Acid Ester Dimer

Both of the methacrylic acid ester and the solvent used had been degasified (disoxidated) in advance, by passing nitrogen gas therethrough for at least an hour.

A reactor equipped with a thermometer, thermostat, stirrer, reflux condenser, nitrogen gas inlet pipe and a dropping device was charged with 30 parts of xylene and 25 parts of ethyl acetate, which were heated to 105° C. while passing nitrogen gas through the liquid, and thereafter a mixture of 100 parts of hydroxypropyl methacrylate, 0.05 part of bis(boron difluorodimethylglyoximate) Co (II) as a metal complex, 1 part of 2,2′-azobis(2-methylbutyronitrile) as a radical polymerization initiator and 15 parts of ethyl acetate as an additive solvent was added dropwise over 3 hours. After completion of the dropping, the reaction mixture was left standing for an hour at 105° C., and further 0.5 part of 2,2′-azobis(2-methylbutyronitrile) and 12 parts of xylene were added dropwise over an hour. After completion of the dropping the reaction mixture was allowed to stand for an hour at 105° C., to provide an oligomer solution (solid content 55%) of hydroxypropyl methacrylate.

From the resultant oligomer solution the xylene and ethyl acetate were removed under reduced pressure to raise the solid content to at least 98%, followed by further reduced pressure distillation, to provide hydroxypropyl methacrylate dimer (abbreviated as HPMA dimer in the Table 1) (yield to the hydroxypropyl methacrylate 90%).

### Synthesis Example 4

### Synthesis of Acrylic Polyol Using Hydroxypropyl Methacrylate Dimer as Chain Transfer Agent

A flask was charged with 30 parts of N-methylpyrrolidone and 15 parts of the hydroxypropyl methacrylate dimer. While blowing nitrogen into the gas phase in the flask, they were heated to 150° C., and into which a liquid mixture of 15 parts of 2-ethylhexyl methacrylate, 43 parts of n-butyl methacrylate, 2 parts of 2-hydroxyethyl methacrylate, 19 parts of diacetone acrylamide, 6 parts of methacrylic acid, 13 parts of N-methylpyrrolidone and 5 parts of PERHEXYL D was added dropwise over 4 hours under stirring. The stirring was continued for further 2 hours in situ, and the reaction mixture was cooled to provide an acrylic polyol solution (AP-2) having a solid content of 70%. Thus obtained acrylic polyol had a number-average molecular weight of 1,920, acid value of 39 mgKOH/g and hydroxyl value of 67 mgKOH/g. The calculated hydroxyl group number per molecule was 2.3.

### Synthesis Example 5

Synthesis Example 4 was repeated except that the monomer blend as shown in later given Table 1 was used, to provide an acrylic polyol solution (AP-8) having a solid content of 70%. The number-average molecular weight, acid value, hydroxyl value and calculated hydroxyl group number per molecule of resultant acrylic polyol are shown in later appearing Table 2.

### Synthesis Example 6

### Synthesis of Acrylic Polyol Using Hydroxyl Group-Containing Thiol Compound as Chain Transfer Agent

A flask was charged with 40 parts of N-methylpyrrolidone which was stirred while blowing nitrogen thereinto at 130° C. and dropwisely adding a mixture of 15 parts of styrene, 16 parts of isobutyl methacrylate, 30 parts of 2-ethylhexyl acrylate, 20 parts of diacetone acrylamide, 10 parts of 2-hydroxyethyl methacrylate, 5 parts of acrylic acid, 4 parts of 2-mercaptoethanol and 4 parts of 2,2′-azobisisobutyronitrile, over 4 hours. After completion of the dropping, the reaction mixture was allowed to stand at 130° C. for an hour, and further a mixed solution of 0.5 part of isobutyronitrile and 3 parts of N-methylpyrrolidone was added dropwise over an hour. The reaction mixture was allowed to stand at 130° C. for an hour after completion of the dropping, to provide an acrylic polyol solution (AP-3) having a solid content of 70%. Thus obtained acrylic polyol had a number-average molecular weight of 1,950, acid value of 39 mgKOH/g and hydroxyl value of 72 mgKOH/g. The calculated hydroxyl group number per molecule was 2.5.

### Synthesis Examples 7-15

Synthesis Example 4 was repeated except that the monomer blends as shown in later appearing Table 1 were used, to provide acrylic polyol solutions (AP-4)-(AP-6) and (AP-9)-(AP-14) each having a solid content of 70%. Number-average molecular weight, acid value, hydroxy value and calculated hydroxyl group number per molecule of each of resultant acrylic polyols are shown in later appearing Table 2.

### Synthesis Example 16

A reactor equipped with a thermometer, thermostat, stirrer, reflux condenser and dropping device was charged with 60 parts of deionized water and 1.7 parts of NEWCOL 707-SF (tradename, Nippon Nyukazai Co., Ltd., polyoxyethylenepolycyclic phenyl ether sulfuric acid ester salt, effective ingredient 30%), which were stirred and mixed in nitrogen gaseous current and heated to 80° C. Then 1% of the total amount of the following monomer emulsion and 5.3 parts of 6% aqueous ammonium persulfate solution were introduced into the reactor and maintained at 80° C. for 15 minutes. Thereafter the remainder of the monomer emulsion was dropped into the reactor maintained at the same temperature over 3 hours, and aged 1 hour after completion of the dropping. Further a polymerization initiator solution formed of 14 parts of deionized water and 0.03 part of ammonium persulfate was added dropwise over an hour, followed by an hour's aging under stirring to provide a copolymer emulsion (AP-15) having a solid content of 38%. Thus obtained copolymer had an acid value of 7 mgKOH/g and hydroxyl value of 43 mgKOH/g.

Monomer emulsion: Monomer emulsion obtained by mixing and stirring 80 parts of deionized water, 3.3 parts of NEWCOL 707-SF, 5 parts of diacetone acrylamide, 10 parts of 2-hydroxyethyl methacrylate, 1 part of methacrylic acid, 15 parts of styrene, 34 parts of isobutyl methacrylate, 20 parts of 2-ethylhexyl acrylate and 15 parts of 2-ethylhexyl methacrylate.

TABLE 1

| | Synthesis Example | | | | | | | | | | | | | | |
|---|---|---|---|---|---|---|---|---|---|---|---|---|---|---|---|
| | 1 | 3 + 4 | 6 | 7 | 8 | 9 | 2 | 3 + 5 | 10 | 11 | 12 | 13 | 14 | 15 | 16 |
| HPMA dimer | | 15 | | | | | | 15 | | | | | | | |
| Diacetone | 20 | 19 | 20 | 20 | 20 | 20 | 20 | 19 | | 20 | 20 | 20 | 20 | 20 | 5 |
| acrylamide | | | | | | | | | | | | | | | |
| 2-Hydroxyethyl | 17 | 2 | 10 | 3 | 10 | 30 | 17 | 30 | 10 | 15.3 | 10 | 10 | 1 | 37 | 10 |
| methacrylate | | | | | | | | | | | | | | | |
| Acrylic acid | 5 | | 5 | 5 | 8 | 5 | 5 | | 5 | 5 | 0.7 | 14 | 5 | 5 | |
| Methacrylic | | 6 | | | | | | 6 | | | | | | | 1 |
| acid | | | | | | | | | | | | | | | |
| 2-Mercapto- | | | 4 | 1 | 4 | 6 | | | 4 | 0.7 | 4 | 4 | 1 | 4 | |
| ethanol | | | | | | | | | | | | | | | |
| Styrene | 15 | | 15 | 15 | 15 | 15 | 15 | | 15 | 15 | 15 | 15 | 15 | 15 | 15 |
| Isobutyl | 13 | | 16 | 26 | 13 | | 13 | | 30 | 14 | 20 | 5 | 28 | | 34 |
| methacrylate | | | | | | | | | | | | | | | |
| n-Butyl | | 43 | | | | | | | | | | | | | |
| methacrylate | | | | | | | | | | | | | | | |
| 2-Ethylhexyl | 30 | | 3 | 30 | 30 | 24 | 20 | | 16 | 30 | 30.3 | 32 | 30 | 19 | 20 |
| acrylate | | | | | | | | | | | | | | | |
| 2-Ethylhexyl | | 15 | | | | | | 30 | 20 | | | | | | 15 |
| methacrylate | | | | | | | | | | | | | | | |
| PERHEXYL D | 4 | 5 | | | | | | 5 | | | | | | | |
| 2,2′- | 0.5 | | 4 + 0.5 | 2 + 0.5 | 4 + | 4 + | 2 + 0.5 | | 4 + 0.5 | 2 + 0.5 | 4 + 0.5 | 4 + 0.5 | 2 + 0.5 | 4 + 0.5 | |
| Azobisisobutyro- | | | | | 0.5 | 0.5 | | | | | | | | | |
| nitrile | | | | | | | | | | | | | | | |
| Acrylic polyol | AP-1 | AP-2 | AP-3 | AP-4 | AP-5 | AP-6 | AP-7 | AP-8 | AP-9 | AP-10 | AP-11 | AP-12 | AP-13 | AP-14 | AP-15 |
| solution | | | | | | | | | | | | | | | |

TABLE 2

| | Synthesis Example | | | | | | | |
|---|---|---|---|---|---|---|---|---|
| | 1 | 3 + 4 | 6 | 7 | 8 | 9 | 2 | 3 + 5 |
| Solid content (wt %) | 70 | 70 | 70 | 70 | 70 | 70 | 70 | 70 |
| Number-average molecular | 1730 | 1920 | 1950 | 7800 | 1950 | 1300 | 11100 | 1920 |
| weight | | | | | | | | |
| Acid value (mgKOH/g) | 39 | 39 | 39 | 39 | 62 | 39 | 39 | 39 |
| Hydroxyl value (mgKOH/g) | 73 | 67 | 72 | 20 | 72 | 173 | 73 | 190 |
| Calculated hydroxyl group | 2.3 | 2.3 | 2.5 | 2.8 | 2.5 | 4.0 | 14.6 | 6.4 |
| number (per molecule) | | | | | | | | |
| Acrylic polyol solution | AP-1 | AP-2 | AP-3 | AP-4 | AP-5 | AP-6 | AP-7 | AP-8 |

| | Synthesis Example | | | | | | |
|---|---|---|---|---|---|---|---|
| | 10 | 11 | 12 | 13 | 14 | 15 | 16 |
| Solid content (wt %) | 70 | 70 | 70 | 70 | 70 | 70 | 38 |
| Number-average molecular | 2340 | 11100 | 1950 | 1950 | 7800 | 1950 | |
| weight | | | | | | | |
| Acid value (mgKOH/g) | 39 | 39 | 6 | 109 | 39 | 39 | 7 |
| Hydroxyl value (mgKOH/g) | 72 | 71 | 72 | 72 | 12 | 190 | 43 |
| Calculated hydroxyl group | 2.5 | 14.1 | 2.5 | 2.5 | 1.6 | 6.5 | |
| number (per molecule) | | | | | | | |
| Acrylic polyol solution | AP-9 | AP-10 | AP-11 | AP-12 | AP-13 | AP-14 | AP-15 |

### Example 1

### Preparation of Urethane Resin-Containing Aqueous Resin Composition

While blowing nitrogen into the gas phase of a flask, the flask was charged with 114 parts of a 70% acrylic polyol solution (AP-1) (solid acrylic polyol content, 80 parts; N-methylpyrrolidone, 34 parts) and 20 parts of dicyclohexylmethane diisocyanate, which were stirred at 90° C. for about 6 hours and cooled to 50° C. Successively, 4 parts of dimethylethanolamine (neutralization equivalent to acidic groups, 0.81) was charged, followed by 10 minutes' stirring in situ and then into which 140 parts of deionized water was added dropwise over 15 minutes. The resultant aqueous dispersion was maintained at 40° C., into which a liquid mixture of 1.2 parts of ethylenediamine as chain-extending agent and 10 parts of deionized water was added dropwise over 15 minutes. Stirring the system in situ at 40° C. for an hour, an aqueous resin composition (ACU-1, solid content 35%, acid value 31 mgKOH/g) which was a milk-white dispersion was obtained.

### Examples 2-9, Comparative Examples 1-10

Example 1 was repeated except that the composition of the components and reaction time were varied as shown in later-appearing Tables 3a and 3b, to prepare aqueous resin compositions (ACU-2)-(ACU-19) each having a solid content of 35%. Acid values and visually observed condition of resultant aqueous resin compositions are concurrently shown in later-appearing Table 3. Condition evaluation of the aqueous resin compositions

The result of evaluating condition of the aqueous resin compositions as prepared in Examples 1-9 and Comparative Examples 1-10 by visual observation are shown in the following Tables 3a and 3b. The aqueous resin compositions of Examples 1-9 and Comparative Examples 1, 2, 5 and 8 were stable milk-white dispersions, but in Comparative Examples 3, 4, 6, 7, 9 and 10 dispersions could not be obtained because of insufficient dispersibility in water of the resins or gelation at the urethanation stage, which caused separate sedimentation or formation of massive gel.

TABLE 3a

| | Example | | | | | | | | |
|---|---|---|---|---|---|---|---|---|---|
| | 1 | 2 | 3 | 4 | 5 | 6 | 7 | 8 | 9 |
| Acrylic polyol solution | AP-1 | AP-2 | AP-3 | AP-4 | AP-5 | AP-6 | AP-3 | AP-6 | AP-3 |
| Blended amount (part) | 114 | 114 | 114 | 129 | 114 | 114 | 114 | 86 | 129 |
| Dicyclohexylmethane | 20 | 20 | 20 | 10 | 20 | 20 | | 40 | 10 |
| diisocyanate (part) | | | | | | | | | |
| Isophorone diisocyanate (part) | | | | | | | 20 | | |
| Hydroxyl group/isocyanate | 0.7 | 0.6 | 0.7 | 0.4 | 0.7 | 1.67 | 0.6 | 0.6 | 1.43 |
| group (molar ratio) | | | | | | | | | |
| Stirring time (hrs.) | 6 | 6 | 6 | 2 | 6 | 20 | 6 | 6 | 2 |
| Dimethylethanolamine (part) | 4 | 4 | 4 | 4 | 4 | 4 | 4 | 3.5 | 4 |
| Acid neutralization equivalent | 0.81 | 0.81 | 0.81 | 0.72 | 0.51 | 0.81 | 0.81 | 0.92 | 0.72 |
| Deionized water (part) | 140 | 140 | 140 | 135 | 140 | 139 | 140 | 142 | 134 |
| Ethylenediamine (part) | 1.2 | 1.2 | 1.2 | 1.2 | 1.2 | 0.5 | 1.2 | 3 | 0.5 |
| Deionized water (part) | 10 | 10 | 10 | 10 | 10 | 10 | 10 | 20 | 10 |
| Solid content (wt %) | 35 | 35 | 35 | 35 | 35 | 35 | 35 | 35 | 35 |
| Acid value (mgKOH/g) | 31 | 31 | 31 | 35 | 49 | 31 | 31 | 23 | 35 |
| Aqueous resin dispersion | ACU-1 | ACU-2 | ACU-3 | ACU-4 | ACU-5 | ACU-6 | ACU-7 | ACU-8 | ACU-9 |
| Condition (visual observation) | milk-white | milk-white | milk-white | milk-white | milk-white | milk-white | milk-white | milk-white | milk-white |
| | dispersion | dispersion | dispersion | dispersion | dispersion | dispersion | dispersion | dispersion | dispersion |

TABLE 3b

| | Comparative Example | | | | | | | | | |
|---|---|---|---|---|---|---|---|---|---|---|
| | 1 | 2 | 3 | 4 | 5 | 6 | 7 | 8 | 9 | 10 |
| Acrylic polyol | AP-6 | AP-3 | AP-7 | AP-8 | AP-9 | AP-10 | AP-11 | AP-12 | AP-13 | AP-14 |
| solution | | | | | | | | | | |
| Blended amount | 43 | 136 | 114 | 114 | 114 | 114 | 114 | 114 | 129 | 114 |
| (part) | | | | | | | | | | |
| Di- | 70 | 5 | 20 | 20 | 20 | 20 | 20 | 20 | 10 | 20 |
| cyclohexylmethane | | | | | | | | | | |
| diisocyanate (part) | | | | | | | | | | |
| Hydroxyl | 0.2 | 3.33 | 0.7 | 1.67 | 0.7 | 0.7 | 0.7 | 0.7 | 0.2 | 1.67 |
| group/isocyanate | | | | | | | | | | |
| group (molar ratio) | | | | | | | | | | |
| Stirring time (hrs.) | 1 | 1 | 6 | 2 | 6 | 6 | 6 | 6 | 1 | 2 |
| Dimethyl- | 1.8 | 4 | 4 | 4 | 4 | 4 | 0.7 | 4 | 4 | 4 |
| ethanolamine (part) | | | | | | | | | | |
| Acid neutralization | 0.97 | 0.68 | 0.81 | 0.8 | 0.81 | 0.81 | 1 | 0.29 | 0.72 | 0.8 |
| equivalent | | | | | | | | | | |
| Deionized water | 163 | 132 | 140 | 139 | 140 | 140 | 143 | 140 | 136 | 139 |
| (part) | | | | | | | | | | |
| Ethylenediamine | 12 | 0.5 | 1.2 | 0.5 | 1.2 | 1.2 | 1.2 | 1.2 | 1.8 | 0.5 |
| (part) | | | | | | | | | | |
| Deionized water | 30 | 10 | 10 | 10 | 10 | 10 | 10 | 10 | 10 | 10 |
| (part) | | | | | | | | | | |
| Solid content (wt %) | 35 | 35 | 35 | 35 | 35 | 35 | 35 | 35 | 35 | 35 |
| Acid value | 10 | 37 | 31 | 31 | 31 | 31 | 4 | 86 | 34 | 31 |
| (mgKOH/g) | | | | | | | | | | |
| Aqueous resin | ACU-10 | ACU-11 | ACU-12 | ACU-13 | ACU-14 | ACU-15 | ACU-16 | ACU-17 | ACU-18 | ACU-19 |
| dispersion | | | | | | | | | | |
| Condition (visual | milk-white | milk-white | massive | massive | milk-white | massive | separate | milk-white | separate | massive |
| observation) | dispersion | dispersion | gel | gel | dispersion | gel | sedimentation | dispersion | sedimentation | gel |

### Example 10

Homogeneously mixing 286 parts (solid content 100 parts) of the aqueous resin composition (ACU-1) as obtained in Example 1, 6.6 parts of adipic dihydrazide and 12 parts of deionized water, water-based paint composition (ST-1) having a solid content of 35% was obtained.

### Examples 11-20, Comparative Examples 11-14, 16

Water-based paint compositions (ST-2)-(ST-15) and (ST-17) each having a solid content of 35% were obtained in the manner similar to Example 10, except that the composition of the components as shown in later-appearing Tables 4a and 4b were used.

### Comparative Example 15

A two-package type water-based paint composition (ST-16) was obtained, which was formed of liquid A: 263 parts of the copolymer emulsion AP-15 as obtained in Synthesis Example 16, and liquid B: an aqueous curing agent solution formed of 18.6 parts of TAKENATE WD-220 (tradename, Mitisui Chemical Polyurethane Co., soap-free type water-dispersible polyisocyanate provided by rendering a polyisocyanate compound easily water-dispersible by introducing nonionic hydrophilic groups), as diluted with 57.3 parts of deionized water.

TABLE 4a

| | Example | | | | | | | | | | |
|---|---|---|---|---|---|---|---|---|---|---|---|
| | 10 | 11 | 12 | 13 | 14 | 15 | 16 | 17 | 18 | 19 | 20 |
| Aqueous resin composition | ACU-1 | ACU-2 | ACU-3 | ACU-3 | ACU-3 | ACU-4 | ACU-5 | ACU-6 | ACU-7 | ACU-8 | ACU-9 |
| Blended amount (part) | 286 | 286 | 286 | 286 | 286 | 286 | 286 | 286 | 286 | 286 | 286 |
| Adipic dihydrazide | 6.6 | 6.6 | 6.6 | | | 7.4 | 6.6 | 6.6 | 6.6 | 5.0 | 7.4 |
| 50% HARDENER SC | | | | 32.8 | 16.4 | | | | | | |
| Deionized water | 12 | 12 | 12 | 13.8 | 6.7 | 13.5 | 12 | 12 | 12 | 12 | 12 |
| Solid content (wt %) | 35 | 35 | 35 | 35 | 35 | 35 | 35 | 35 | 35 | 35 | 35 |
| Water-based paint composition | ST-1 | ST-2 | ST-3 | ST-4 | ST-5 | ST-6 | ST-7 | ST-8 | ST-9 | ST-10 | ST-11 |

TABLE 4b

| | Comparative Example | | | | | |
|---|---|---|---|---|---|---|
| | 11 | 12 | 13 | 14 | 15 | 16 |
| Aqueous resin composition | ACU-10 | ACU-11 | ACU-14 | ACU-17 | AP-15 | AP-15 |
| Blended amount (part) | 286 | 286 | 286 | 286 | 263 | 263 |
| Adipic dihydrazide | 3.3 | 7.8 | 6.6 | 6.6 | | 2.1 |
| TAKENATE WD-220 | | | | | 18.6 | |
| Deionized water | 5.8 | 14.2 | 12 | 12 | 57.3 | 26.6 |
| Solid content (wt %) | 35 | 35 | 35 | 35 | 35 | 35 |
| Water-based paint composition | ST-12 | ST-13 | ST-14 | ST-15 | ST-16 | ST-17 |

### Performance Evaluation of Water-Based Paint Compositions

Test panels coated with the water-based paint compositions as obtained in Examples 10-20 and Comparative Examples 11-16 were prepared as follows.

As the material, solid aluminum sheets (150×70×0.5 mm) whose surfaces were roughened with #400 sand paper to an extent they appeared dull and then degreased with xylene were used. The sheets were coated with each of the water-based paint compositions with a brush, at an application rate of 100 g/m². After one day's drying, a second time coating was given in the manner similar to the first time coating, and dried at atmospheric temperature of 20° C. and relative humidity of 60% for 7 days to provide the test panels. In Comparative Example 15, the two packages were mixed 15 minutes before the coating.

Then the performance evaluations were given as to the following items.

1. Rubbing test: About 2 ml of methyl ethyl ketone was put on the coated sheet surface, on which a double gauze (FC gauze, Hakujuji Co., Ltd.) quarto was applied, pressed against the sheet and rubbed the spot with the middle finger, at a stroke length of 5 cm 20 reciprocal times. Conditions of the coated sheet thereafter was evaluated by visual observation.
◯: No change such as cracks or fog occurred on the coated Surface.
Δ: Fine cracks were formed at the rubbed spot and gloss was visibly degraded.
x: Coating film was broken and came off, not remaining on the coated sheet.

2. Bending test: Each test sheet was cut into 20 mm-wide ribbon form and bent by 180°, along a round rod of 10 mm in diameter which was applied on the uncoated back surface of the ribbon sheet. Condition of the bent portion after 5 minutes was evaluated by visual observation.
◯: No change such as cracks or fog occurred on the coated surface.
Δ: Clear gloss degradation or faint whitening was observed at the bent portion.
x: Coating film at the bent portion was broken.

3. Pencil hardness: Following JIS K5600-5-4 (1999), a pencil lead was applied on the coated test panel surface at an angle of 45° and moved forward by about 10 mm at a uniform rate, being forcedly pressed against the coated test panel surface to an extent not to break the lead. This operation was repeated 5 times at different places, and hardness mark of the hardest pencil which did not break the coating film was recorded as the pencil hardness.

4. Water resistance test: Test panels were immersed in 50° C. warm water for 60 minutes, withdrawn and wiped off of the water drops on the surfaces. Condition of each coated surface then was evaluated by visual observation:
◯: No change occurred on the coates surface.
Δ: Coated surface was whitened but the transparent coated surface was restored after 24 hours' standing.
x: Coated surface was notably whitened, and the coating film easily came off under gentle rubbing.

The results are shown in the following Table 5.

TABLE 5

| | Example | | | | | | | | | | | Comparative Example | | | | | |
|---|---|---|---|---|---|---|---|---|---|---|---|---|---|---|---|---|---|
| | 10 | 11 | 12 | 13 | 14 | 15 | 16 | 17 | 18 | 19 | 20 | 11 | 12 | 13 | 14 | 15 | 16 |
| Water- | ST-1 | ST-2 | ST-3 | ST-4 | ST-5 | ST-6 | ST-7 | ST-8 | ST-9 | ST-10 | ST-11 | ST-12 | ST-13 | ST-14 | ST-15 | ST-16 | ST-17 |
| based | | | | | | | | | | | | | | | | | |
| paint | | | | | | | | | | | | | | | | | |
| compo- | | | | | | | | | | | | | | | | | |
| sition | | | | | | | | | | | | | | | | | |
| Rub | ◯ | ◯ | ◯ | ◯ | ◯ | ◯ | ◯ | ◯ | ◯ | ◯ | ◯ | Δ | Δ | X | Δ | ◯ | ◯ |
| bing | | | | | | | | | | | | | | | | | |
| Bend- | ◯ | ◯ | ◯ | ◯ | ◯ | ◯ | ◯ | ◯ | ◯ | ◯ | ◯ | Δ | X | Δ | Δ | ◯ | Δ |
| ing | | | | | | | | | | | | | | | | | |
| Pencil | 2H | 2H | 2H | H | H | H | F | H | F | F | H | H | 2H | 2B | H | 2H | B |
| hard- | | | | | | | | | | | | | | | | | |
| ness | | | | | | | | | | | | | | | | | |
| Water | ◯ | ◯ | ◯ | ◯ | ◯ | ◯ | ◯ | ◯ | ◯ | ◯ | ◯ | ◯ | ◯ | X | X | ◯ | ◯ |
| resist- | | | | | | | | | | | | | | | | | |
| ance | | | | | | | | | | | | | | | | | |

### Synthesis Example 17

### Synthesis of Acrylic Polyol not Using a Chain Transfer Agent

A flask was charged with 40 parts of N-methylpyrrolidone which was stirred while nitrogen was blown thereinto at 150° C., into which a mixture of 25 parts of diacetone acrylamide, 17 parts of 2-hydroxyethyl methacrylate, 1 part of acrylic acid, 15 parts of styrene, 12 parts of isobutyl methacrylate, 30 parts of 2-ethylhexyl acrylate and 6 parts of PERHEXYL D was added dropwise over 4 hours. After completion of the dropping, the reaction mixture was left standing at 150° C. for an hour, and further a mixed solution of 0.5 part of 2,2′-azobis(2-methylbutyronitrile) and 3 parts of N-methylpyrrolidone was added dropwise over 30 minutes. After completion of the dropping the reaction mixture was left standing at 150° C. for an hour, to provide an acrylic polyol solution (AP-16) having a solid content of 70%. The resultant acrylic polyol had a number-average molecular weight of 1,730, acid value of 7.8 mgKOH/g and hydroxyl value of 73 mgKOH/g. The calculated hydroxyl group number per molecule was 2.3.

### Synthesis Example 18

### Synthesis Example 17 was repeated except that the monomer blend as shown in Table 6 was used and the temperature was lowered to 130° C., to provide an acrylic polyol solution (AP-23) having a solid content of 70%. The number-average molecular weight, acid value, hydroxyl value and calculated hydroxyl group number per molecule of the resultant acrylic polyol were as shown in Table 7.

### Synthesis Example 19

### Synthesis of Acrylic Polyol Using Hydroxypropyl Methacrylate Dimer as the Chain Transfer Agent

A flask was charged with 30 parts of N-methylpyrrolidone and 15 parts of the hydroxypropyl methacrylate dimer as obtained in Synthesis Example 3, and while blowing nitrogen into the gas phase, the content of the flask was heated to 150° C. Into the flask then a liquid mixture of 25 parts of diacetone acrylamide, 2 parts of 2-hydroxyethyl methacrylate, 1 part of methacrylic acid, 30 parts of n-butyl methacrylate, 27 parts of 2-ethylhexyl methacrylate, 13 parts of N-methylpyrrolidone and 5 parts of PERHEXYL D was added dropwise under stirring, over 4 hours. Continuing the stirring in situ for further 2 hours and then cooling the reaction mixture, an acrylic polyol solution (AP-17) having a solid content of 70% was obtained. The resultant acrylic polyol had a number-average molecular weight of 1,920, acid value of 6.5 mgKOH/g and hydroxyl value of 67 mgKOH/g. The calculated hydroxyl group number per molecule was 2.3.

### Synthesis Example 20

Synthesis Example 19 was repeated except that the monomer blend as shown in Table 6 was used, to provide an acrylic polyol solution (AP-24) having a solid content of 70%. The number-average molecular weight, acid value, hydroxyl value and calculated hydroxyl group number per molecule of the resultant acrylic polyol were as shown in Table 7.

### Synthesis Example 21

### Synthesis of Acrylic Polyol Using Hydroxyl Group-Containing Thiol Compound as the Chain Transfer Agent

A flask was charged with 40 parts of N-methylpyrrolidone which was stirred while nitrogen was blown thereinto at 130° C., into which a mixture of 25 parts of diacetone acrylamide, 10 parts of 2-hydroxyethyl methacrylate, 1 part of acrylic acid, 4 parts of 2-mercaptoethanol, 15 parts of styrene, 15 parts of isobutyl methacrylate, 30 parts of 2-ethylhexyl acrylate and 4 parts of 2,2′-azobisisobutyronitrile was added dropwise over 4 hours. After completion of the dropping, the system was left standing at 130° C. for an hour, and further a mixed solution of 0.5 part of 2,2′-azobis(isobutyronitrile) and 3 parts of N-methylpyrrolidone was added dropwise over an hour. After completion of the dropping, the reaction mixture was left standing at 130° C. for an hour, to provide an acrylic polyol solution (AP-18) having a solid content of 70%. The resultant acrylic polyol had a number-average molecular weight of 1,950, acid value of 7.8 mgKOH/g and hydroxyl value of 72 mgKOH/g. The calculated hydroxyl group number per molecule was 2.5.

### Synthesis Examples 22-30

Synthesis Example 21 was repeated except that the compositions of the components as shown in Table 6 were used, to provide acrylic polyol solutions (AP-19)-(AP-22) and (AP-25)-(AP-29) each having a solid content of 70%. The number-average molecular weight, acid value, hydroxyl value and calculated hydroxyl group number per molecule of each of the resultant acrylic polyols were as shown in Table 7.

### Synthesis Example 31

A reactor equipped with a thermometer, thermostat, stirrer, reflux condenser and dropping device was charged with 60 parts of deionized water and 1.7 parts of NEWCOL 707 SF which were then stirred and mixed in gaseous nitrogen current and given a temperature rise to 80° C. Thereafter 1% of the total amount of the later given monomer emulsion and 5.3 parts of 6% aqueous ammonium persulfate were introduced into the reactor and kept at 80° C. for 15 minutes. Subsequently, the rest of the monomer emulsion was dropped into the reactor which was maintained at the same temperature, over 3 hours, followed by 1 hour's aging. Then a polymerization initiator solution formed of 14 parts of deionized water and 0.03 part of ammonium persulfate was dropped over an hour. Aging the reaction mixture under stirring for an hour after completion of the dropping, a copolymer emulsion (AP-30) having a solid content of 38% was obtained. The resultant copolymer had an acid value of 7 mgKOH/g and a hydroxyl value of 43 mgKOH/g.

Monomer emulsion: Mixing and stirring 80 parts of deionized water, 3.3 parts of NEWCOL 707-SF, 5 parts of diacetone acrylamide, 10 parts of 2-hydroxyethyl methacrylate, 1 part of methacrylic acid, 15 parts of styrene, 34 parts of isobutyl methacrylate, 20 parts of 2-ethylhexyl acrylate and 15 parts of 2-ethylhexyl methacrylate, the monomer emulsion was obtained.

TABLE 6

| | Synthesis Example | | | | | | | | | | | | | |
|---|---|---|---|---|---|---|---|---|---|---|---|---|---|---|
| | 17 | 3 + 19 | 21 | 22 | 23 | 24 | 25 | 18 | 3 + 20 | 26 | 27 | 28 | 29 | 30 |
| HPMA dimer | | 15 | | | | | | | 15 | | | | | |
| Diacetone | 25 | 25 | 25 | 25 | 25 | 25 | 25 | 25 | 25 | | 25 | 25 | 25 | 25 |
| acrylamide | | | | | | | | | | | | | | |
| 2-Hydroxyethyl | 17 | 2 | 10 | 10 | 30 | 10 | 30 | 17 | 30 | 10 | 15.3 | 10 | 1 | 37 |
| methacrylate | | | | | | | | | | | | | | |
| Acrylic acid | 1 | | 1 | | 1 | 5 | 1 | 1 | | 1 | 1 | 14 | 1 | 1 |
| Methacrylic | | 1 | | | | | | | 1 | | | | | |
| acid | | | | | | | | | | | | | | |
| 2-Mercapto- | | | 4 | 4 | 1 | 4 | 6 | | | 4 | 0.7 | 4 | 1 | 4 |
| ethanol | | | | | | | | | | | | | | |
| Styrene | 15 | | 15 | 15 | 15 | 15 | 10 | 15 | | 15 | 15 | 15 | 15 | 15 |
| Isobutyl | 12 | | 15 | 16 | 20 | 11 | | 12 | | 30 | 13 | | 27 | |
| methacrylate | | | | | | | | | | | | | | |
| n-Butyl | | 30 | | | | | | | | | | | | |
| methacrylate | | | | | | | | | | | | | | |
| 2-Ethylhexyl | 30 | | 30 | 30 | 35 | 30 | 28 | 30 | | 20 | 30 | 32 | 30 | 18 |
| acrylate | | | | | | | | | | | | | | |
| 2-Ethylhexyl | | 27 | | | | | | | 29 | 20 | | | | |
| methacrylate | | | | | | | | | | | | | | |
| PERHEXYL D | 6 | 5 | | | | | | | 5 | | | | | |
| 2,2′- | 0.5 | | 4 + | 4 + 0.5 | 2 + 0.5 | 4 + 0.5 | 4 + 0.5 | 2.5 + 0.5 | | 4 + 0.5 | 2 + 0.5 | 4 + 0.5 | 2 + 0.5 | 4 + 0.5 |
| Azobisisobutyro- | | | 0.5 | | | | | | | | | | | |
| nitrile | | | | | | | | | | | | | | |

TABLE 7

| | Synthesis Example | | | | | | | | | | | | | |
|---|---|---|---|---|---|---|---|---|---|---|---|---|---|---|
| | 17 | 3 + 19 | 21 | 22 | 23 | 24 | 25 | 18 | 3 + 20 | 26 | 27 | 28 | 29 | 30 |
| Solid content | 70 | 70 | 70 | 70 | 70 | 70 | 70 | 70 | 70 | 70 | 70 | 70 | 70 | 70 |
| (wt %) | | | | | | | | | | | | | | |
| Number- | 1730 | 1920 | 1950 | 1950 | 7800 | 1950 | 1300 | 11100 | 1920 | 1950 | 11100 | 1950 | 7800 | 1950 |
| average | | | | | | | | | | | | | | |
| molecular | | | | | | | | | | | | | | |
| weight | | | | | | | | | | | | | | |
| Acid value | 7.8 | 6.5 | 7.8 | 0 | 7.8 | 39 | 7.8 | 7.8 | 6.5 | 7.8 | 7.8 | 109 | 7.8 | 7.8 |
| (mgKOH/g) | | | | | | | | | | | | | | |
| Hydroxyl value | 73 | 67 | 72 | 72 | 20 | 72 | 173 | 73 | 188 | 72 | 71 | 72 | 12 | 188 |
| (mgKOH/g) | | | | | | | | | | | | | | |
| Calculated | 2.3 | 2.3 | 2.5 | 2.5 | 2.8 | 2.5 | 4.0 | 14.6 | 6.4 | 2.5 | 14.1 | 2.5 | 1.6 | 6.6 |
| hydroxyl group | | | | | | | | | | | | | | |
| number/ | | | | | | | | | | | | | | |
| molecule | | | | | | | | | | | | | | |
| Acrylic | AP-16 | AP-17 | AP-18 | AP-19 | AP-20 | AP-21 | AP-22 | AP-23 | AP-24 | AP-25 | AP-26 | AP-27 | AP-28 | AP-29 |
| polyol solution | | | | | | | | | | | | | | |

### Example 21

### Preparation of Aqueous Resin Composition Containing Urethane Resin

A flask was charged with 100 parts of the 70% acrylic polyol solution (AP-16) (solid acrylic polyol content 70 parts, N-methylpyrrolidone 30 parts), 5 parts of dimethylolpropionic acid and 25 parts of dicyclohexylmethane diisocyanate, while nitrogen was blown into the gas phase in the flask. After stirring at 90° C. for about 6 hours, the reaction mixture was cooled to 50° C. Then 3.5 parts of dimethylethanolamine (neutralization equivalent to acidic group was 0.84) was charged, followed by 10 minutes' stirring in situ, and into which 144 parts of deionized water was added dropwise over 15 minutes. The resultant aqueous dispersion was maintained at 40° C., into which a liquid mixture of 0.7 part of ethylenediamine as a chain extending agent and 10 parts of deionized water was added dropwise over 15 minutes. The reaction mixture was stirred in situ at 40° C. for an hour, to provide an aqueous resin composition (ACU-20, solid content 35%, acid value 26 mgKOH/g).

### Examples 22-30, Comparative Examples 17-27

Example 21 was repeated except that the composition of the components and the reaction time were varied as shown in Tables 8a and 8b, to prepare aqueous resin compositions (ACU-21)-(ACU-40) each having a solid content of 35%. Acid values and visually observed condition of resultant aqueous resin compositions are concurrently shown in later-appearing Table 8.

### Condition Evaluation of the Aqueous Resin Compositions

The result of evaluating condition of the aqueous resin compositions as prepared in Examples 21-30 and Comparative Examples 17-27 by visual observation are shown in the following Tables 8a and 8b. The aqueous resin compositions of Examples 21-30 and Comparative Examples 17-19, 23 and 25 were stable milk-white dispersions, but in Comparative Examples 20, 21, 22, 24, 26 and 27 dispersions could not be obtained because of insufficient dispersibility in water of the resins or gelation at the urethanation stage, which caused separate sedimentation or formation of massive gel.

TABLE 8a

| | Example | | | | | | | | | |
|---|---|---|---|---|---|---|---|---|---|---|
| | 21 | 22 | 23 | 24 | 25 | 26 | 27 | 28 | 29 | 30 |
| Acrylic polyol solution | AP-16 | AP-17 | AP-18 | AP-19 | AP-20 | AP-21 | AP-22 | AP-23 | AP-24 | AP-25 |
| Blended amount (part) | 100 | 100 | 100 | 100 | 114 | 107 | 86 | 100 | 71 | 114 |
| Dimethylolpropionic acid | 5 | 5 | 5 | 5 | 4.5 | 3 | 8 | 6 | 7 | 2 |
| (part) | | | | | | | | | | |
| Dicyclohexylmethane | 25 | 25 | 25 | 25 | 15.5 | 22 | 32 | | 43 | 18 |
| diisocyanate (part) | | | | | | | | | | |
| Isophorone diisocyanate (part) | | | | | | | | 24 | | |
| Hydroxyl group/isocyanate | 0.9 | 0.8 | 0.8 | 0.9 | 0.8 | 0.8 | 1.25 | 0.8 | 0.8 | 0.9 |
| group (molar ratio) | | | | | | | | | | |
| Stirring time (hrs.) | 6 | 6 | 6 | 6 | 6 | 6 | 3 | 6 | 6 | 6 |
| Dimethylethanolamine | 3.5 | 3.5 | 3.5 | 3.2 | 3.5 | 3.5 | 3.5 | 3.5 | 3.5 | 2.3 |
| Acid neutralization equivalent | 0.84 | 0.87 | 0.84 | 0.96 | 0.88 | 0.53 | 0.58 | 0.88 | 0.66 | 0.99 |
| Deionized water (part) | 144 | 144 | 144 | 144 | 139 | 142 | 147 | 144 | 154 | 139 |
| Ethylenediamine (part) | 0.7 | 0.9 | 0.7 | 0.7 | 0.6 | 0.8 | 0.5 | 1.1 | 1.8 | 0.5 |
| Deionized water (part) | 10 | 10 | 10 | 10 | 10 | 10 | 10 | 10 | 10 | 10 |
| Solid content (wt %) | 35 | 35 | 35 | 35 | 35 | 35 | 35 | 35 | 35 | 35 |
| Acid value (mgKOH/g) | 26 | 25 | 26 | 21 | 25 | 41 | 38 | 25 | 33 | 15 |
| Aqueous resin dispersion | ACU-20 | ACU-21 | ACU-22 | ACU-23 | ACU-24 | ACU-25 | ACU-26 | ACU-27 | ACU-28 | ACU-29 |
| Condition (visual observation) | milk-white | milk-white | milk-white | milk-white | milk-white | milk-white | milk-white | milk-white | milk-white | milk-white |
| | dispersion | dispersion | dispersion | dispersion | dispersion | dispersion | dispersion | dispersion | dispersion | dispersion |

TABLE 8b

| | Example | | | | | | | | | | |
|---|---|---|---|---|---|---|---|---|---|---|---|
| | 17 | 18 | 19 | 20 | 21 | 22 | 23 | 24 | 25 | 26 | 27 |
| Acrylic polyol | AP-22 | AP-21 | AP-21 | AP-18 | AP-23 | AP-24 | AP-25 | AP-26 | AP-27 | AP-28 | AP-29 |
| solution | | | | | | | | | | | |
| Blended amount | 43 | 129 | 114 | 71 | 100 | 100 | 100 | 100 | 100 | 100 | 100 |
| (part) | | | | | | | | | | | |
| Dimethylolpropionic | 18 | 1 | | 32 | 5 | 5 | 5 | 5 | 5 | 5 | 5 |
| acid (part) | | | | | | | | | | | |
| Di- | 52 | 9 | 20 | 18 | 25 | 25 | 25 | 25 | 25 | 25 | 25 |
| cyclohexylmethane | | | | | | | | | | | |
| diisocyanate (part) | | | | | | | | | | | |
| Hydroxyl | 0.97 | 2.0 | 0.7 | 3.33 | 0.9 | 1.67 | 0.9 | 0.9 | 0.9 | 0.5 | 1.67 |
| group/isocyanate | | | | | | | | | | | |
| group (molar ratio) | | | | | | | | | | | |
| Stirring time (hrs.) | 6 | 3 | 6 | 1 | 6 | 3 | 6 | 6 | 6 | 6 | 3 |
| Dimethyl- | 3.5 | 3.5 | 3.5 | 3.5 | 3.5 | 3.5 | 3.5 | 3.5 | 3.5 | 3.5 | 3.5 |
| ethanolamine | | | | | | | | | | | |
| (part) | | | | | | | | | | | |
| Acid neutralization | 0.28 | 0.56 | 0.71 | 0.16 | 0.84 | 0.87 | 0.84 | 0.84 | 0.23 | 0.84 | 0.84 |
| equivalent | | | | | | | | | | | |
| Deionized water | 161 | 135 | 141 | 151 | 144 | 143 | 144 | 144 | 144 | 148 | 143 |
| (part) | | | | | | | | | | | |
| Ethylenediamine | 0.7 | 0.5 | 1.4 | 0.5 | 0.7 | 0.5 | 0.7 | 0.7 | 0.7 | 3 | 0.5 |
| (part) | | | | | | | | | | | |
| Deionized water | 10 | 10 | 10 | 10 | 10 | 10 | 10 | 10 | 10 | 10 | 10 |
| (part) | | | | | | | | | | | |
| Solid content (wt %) | 35 | 35 | 35 | 35 | 35 | 35 | 35 | 35 | 35 | 35 | 35 |
| Acid value | 77 | 39 | 31 | 137 | 26 | 25 | 26 | 26 | 97 | 26 | 26 |
| (mgKOH/g) | | | | | | | | | | | |
| Aqueous resin | ACU- | ACU-31 | ACU-32 | ACU-33 | ACU-34 | ACU-35 | ACU-36 | ACU-37 | ACU-38 | ACU-39 | ACU-40 |
| dispersion | 30 | | | | | | | | | | |
| Condition (visual | milk- | milk-white | milk-white | separate | massive | massive | milk-white | massive | milk-white | separate | massive |
| observation) | white | dispersion | dispersion | sedimen- | gel | gel | dispersion | gel | dispersion | sedimen- | gel |
| | dis- | | | tation | | | | | | tation | |
| | persion | | | | | | | | | | |

### Example 31

Homogeneously mixing 286 parts (solid content 100 parts) of the aqueous resin composition (ACU-20) as obtained in Example 21, 7.2 parts of adipic dihydrazide and 13 parts of deionized water, water-based paint composition (ST-18) having a solid content of 35% was obtained.

### Examples 32-42, Comparative Examples 28-32, 34

Water-based paint compositions (ST-19)-(ST-34) and (ST-36) each having a solid content of 35% were obtained in the manner similar to Example 31, except that the composition of the components as shown in the later-appearing Tables 9a and 9b were used.

### Comparative Example 33

A two-package type water-based paint composition (ST-35) was obtained, which was formed of liquid A: 263 parts of the copolymer emulsion AP-30 as obtained in Synthesis Example 31, and liquid B: an aqueous curing agent solution formed of 18.6 parts of TAKENATE WD-220 as diluted with 57.3 parts of deionized water.

TABLE 9a

| | Example | | | | | | | | | | | |
|---|---|---|---|---|---|---|---|---|---|---|---|---|
| | 31 | 32 | 33 | 34 | 35 | 36 | 37 | 38 | 39 | 40 | 41 | 42 |
| Aqueous | ACU- | ACU- | ACU- | ACU- | ACU-23 | ACU-23 | ACU-24 | ACU-25 | ACU-26 | ACU-27 | ACU-28 | ACU-29 |
| resin | 20 | 21 | 22 | 23 | | | | | | | | |
| composition | | | | | | | | | | | | |
| Blended | 286 | 286 | 286 | 286 | 286 | 286 | 286 | 286 | 286 | 286 | 286 | 286 |
| amount (part) | | | | | | | | | | | | |
| Adipic | 7.2 | 7.2 | 7.2 | 7.2 | | | 8.2 | 7.7 | 6.2 | 7.2 | 5.2 | 8.2 |
| dihydrazidez | | | | | | | | | | | | |
| 50% | | | | | 36 | 18 | | | | | | |
| HARDENER | | | | | | | | | | | | |
| SC | | | | | | | | | | | | |
| Deionized | 13 | 13 | 13 | 13 | 15 | 8 | 15 | 14 | 11 | 13 | 10 | 15 |
| water | | | | | | | | | | | | |
| Solid | 35 | 35 | 35 | 35 | 35 | 35 | 35 | 35 | 35 | 35 | 35 | 35 |
| content (wt %) | | | | | | | | | | | | |
| Water-based | ST-18 | ST-19 | ST-20 | ST-21 | ST-22 | ST-23 | ST-24 | ST-25 | ST-26 | ST-27 | ST-28 | ST-29 |
| paint | | | | | | | | | | | | |
| composition | | | | | | | | | | | | |

TABLE 9b

| | Comparative Example | | | | | | |
|---|---|---|---|---|---|---|---|
| | 28 | 29 | 30 | 31 | 32 | 33 | 34 |
| Aqueous resin composition | ACU-30 | ACU-31 | ACU-32 | ACU-36 | ACU-38 | AP-30 | AP-30 |
| Blended amount (part) | 286 | 286 | 286 | 286 | 286 | 263 | 263 |
| Adipic dihydrazide | 3.1 | 9.3 | 8.2 | 7.2 | 7.2 | | 2.1 |
| TAKENATE WD-220 | | | | | | 18.6 | |
| Deionized water | 6 | 17 | 15 | 13 | 13 | 57.3 | 26.6 |
| Solid content (wt %) | 35 | 35 | 35 | 35 | 35 | 35 | 35 |
| Water-based paint composition | ST-30 | ST-31 | ST-32 | ST-33 | ST-34 | ST-35 | ST-36 |

### Performance Evaluation of Water-Based Paint Compositions

### Evaluation of Paint's Storage Stability

Storage stability of the water-based paint compositions as obtained in Examples 31-42 and Comparative Examples 28-34 (excluding 33) was evaluated as follows. One-hundred (100) ml of each water-based paint composition sample was placed in a glass mayonnaise bottle of 125 ml in capacity, hermetically sealed and stored in a 40° C. high temperature room in stand-still condition. The condition of each paint after a month was evaluated by visual observation:
◯: no change from the condition before the storage;
x: paint separation or gelation occurred as notable change.

Then, following the earlier described performance evaluation, the rubbing test, bending test, pencil hardness and water resistance test were conducted.

The results are shown in the following Tables 10a and 10b.

TABLE 10a

| | | Example | | | | | | | | | | | |
|---|---|---|---|---|---|---|---|---|---|---|---|---|---|
| | | 31 | 32 | 33 | 34 | 35 | 36 | 37 | 38 | 39 | 40 | 41 | 42 |
| Water-based | | ST-18 | ST-19 | ST-20 | ST-21 | ST-22 | ST-23 | ST-24 | ST-25 | ST-26 | ST-27 | ST-28 | ST-29 |
| paint composition | | | | | | | | | | | | | |
| Storage stability | | ◯ | ◯ | ◯ | ◯ | ◯ | ◯ | ◯ | ◯ | ◯ | ◯ | ◯ | ◯ |
| Coating film | rubbing | ◯ | ◯ | ◯ | ◯ | ◯ | ◯ | ◯ | ◯ | ◯ | ◯ | ◯ | ◯ |
| performance | bending | ◯ | ◯ | ◯ | ◯ | ◯ | ◯ | ◯ | ◯ | ◯ | ◯ | ◯ | ◯ |
| | pencil hardness | 2H | 2H | 2H | 2H | H | H | 2H | 2H | 2H | H | H | 2H |
| | water resistance | ◯ | ◯ | ◯ | ◯ | ◯ | ◯ | ◯ | ◯ | ◯ | ◯ | ◯ | ◯ |

TABLE 10b

| | | Comparative Example | | | | | | |
|---|---|---|---|---|---|---|---|---|
| | | 28 | 29 | 30 | 31 | 32 | 33 | 34 |
| Water-based | | ST-30 | ST-31 | ST-32 | ST-33 | ST-34 | ST-35 | ST-36 |
| paint composition | | | | | | | | |
| Storage stability | | ◯ | ◯ | X | ◯ | X | | ◯ |
| Coating film | rubbing | Δ | X | ◯ | X | Δ | ◯ | ◯ |
| performance | bending | Δ | X | ◯ | ◯ | ◯ | ◯ | Δ |
| | pencil hardness | H | 2H | 2H | 2B | B | 2H | B |
| | water resistance | X | X | ◯ | X | X | ◯ | ◯ |

1. An aqueous resin composition containing a urethane resin as dispersed in an aqueous medium, which is obtained through reaction of 50-90 mass % of (A) acrylic polyol formed by copolymerization of carbonyl functional group-containing unsaturated monomer, hydrophilic group-containing unsaturated monomer and, where necessary, still other unsaturated monomer; with 10-50 mass % of (B) polyisocyanate compound, based on the total mass of the components (A) and (B).

2. An aqueous resin composition according to claim 1, in which the carbonyl group-containing unsaturated monomer is diacetone acrylamide or diacetone methacrylamide.

3. An aqueous resin composition according to claim 1, in which the hydrophilic group-containing unsaturated monomer is a carboxyl group-containing unsaturated monomer, in particular, acrylic acid or methacrylic acid.

4. An aqueous resin composition according to claim 1, in which the acrylic polyol (A) has a number-average molecular weight within a range of 400-10,000, an acid value not higher than 100 mgKOH/g and a hydroxyl value within a range of 15-180 mgKOH/g.

5. An aqueous resin composition according to claim 1, in which the polyisocyanate compound (B) is a diisocyanate compound.

6. An aqueous resin composition according to claim 1, in which the urethane resin is obtained by reaction of 50-80 mass % of the acrylic polyol (A) with 10-49.9 mass % of the polyisocyanate compound (B) and 0.1-30 mass % of a carboxyl group-containing diol (C), based on the total mass of the components (A), (B) and (C).

7. An aqueous resin composition according to claim 6, in which the carboxyl group-containing diol (C) is selected from dimethylol-propionic acid, dimethylolbutanoic acid and dimethylolvaleric acid.

8. An aqueous resin composition according to claim 6, in which the acrylic polyol (A) has a number-average molecular weight within a range of 400-10,000, an acid value not higher than 50 mgKOH/g and a hydroxyl value within a range of 15-180 mgKOH/g.

9. An aqueous resin composition according to claim 1, in which the urethane resin has an acid value within a range of 5-50 mgKOH/g.

10. An aqueous resin composition according to claim 1, which further contains a crosslinking agent selected from hydrazine compound and hydrazide compound.

11. A one-package type water-based paint composition which contains an aqueous resin composition as described in claim 1.

12. Articles coated with the one-package type water-based paint composition as described in claim 11.

13. Use of the aqueous resin composition which is described in claim 1, as a binder of air drying type paint.
